(19) United States
(12) Patent Application Publication
(10) Pub. No.: US 2022/0377994 A1
(43) Pub. Date: Dec. 1, 2022

(54) EXTENDED TERM HYDROPONIC CULTIVATION APPARATUS AND METHOD

(71) Applicant: Alex Stubblefield, Pomona, CA (US)

(72) Inventor: Alex Stubblefield, Pomona, CA (US)

(21) Appl. No.: 17/303,408

(22) Filed: May 28, 2021

(51) Int. Cl. A01G 31/02; G05D 9/02

(52) U.S. Cl. CPC A01G 31/02; G05D 9/02

(57) ABSTRACT

An extended term hydroponic cultivation apparatus and method provide a growth environment for a plant to develop an oxygen root structure and a water root structure as the plant matures. The root structure of the plant is carried in a growth chamber containing an initial water level with an air gap defined above the water level for development of the oxygen root structure in the air gap. Water root structure development progresses downwardly to a bottom of the growth chamber as the plant consumes water contained within the system until reaching a terminal growth length in a terminal water level. A float valve maintains the water in the system at the terminal water level to sustain plant growth for an extended temporal duration. A drain valve allows for evacuation of water for replenishment with a fresh source of water to the terminal water level.

### BACKGROUND OF THE INVENTION

The present invention relates to, and more particularly to plant cultivation, and more particularly to plant cultivation according to the Kratky method. The Kratky method was discovered in 2009 as a no power hydroponic method. The current uses of the Kratky method are limited to small leafy plants, typically with short life spans.

Apparatus for employing the Kratky method are limited to plants with short life spans due to difficulty in maintaining water levels at a desired level to properly balance the exposure of a plant's oxygen roots with its water roots. Accordingly, such apparatus are typically limited to the cultivation of small leafy plants with short life spans.

As can be seen, there is a need for an improved apparatus and method for extended term plant cultivation utilizing the Kratky method.

### SUMMARY OF THE INVENTION

In one aspect of the present invention, an extended term hydroponic cultivation apparatus is provided that includes a growth chamber having at least one sidewall, a top end, and a bottom end. The growth chamber is dimensioned to contain a root structure growth for a plant from an initial stage at a top end of the growth chamber through a terminal stage at a bottom of the growth chamber. A float valve chamber and a base in fluid communication with the float valve chamber and the growth chamber are provided. A float valve has a float carried within the float valve chamber. The float valve is configured for communication with a water source to selectively replenish a water level within the growth chamber when the root structure growth for the plant has reached the terminal stage.

In some embodiments, a growth basked is adapted to contain a portion of the root structure growth of the plant. The growth basket is coupled with the top end of the growth chamber.

In some embodiments, a plurality of growth chambers are disposed in a spaced apart relation. A conduit interconnects each of the plurality of growth chambers with the float valve chamber.

In some embodiments, a reservoir operatively coupled with the float valve. The reservoir is configured to provide a gravity feed of a quantity of water carried within the reservoir to the float valve.

In some embodiments, a drain valve is coupled to the base. The drain valve is selectively operable between an open position and a closed position. In the open condition, a quantity of water may be evacuated from the base.

In some embodiments, a height of the growth chamber is selected based on a mature length of the root structure growth of the plant.

In some embodiments, the growth chamber may include a bucket.

In other aspects of the invention, an extended term hydroponic cultivation system is provided. The system includes a base configured to contain a quantity of water. An upright growth chamber is in fluid communication with the base. The upright growth chamber is defined by at least one cylindrical sidewall and is dimensioned to contain a root structure of a plant from an initial growth stage to a terminal growth stage. A float valve chamber is in fluid communication with the base. The float valve chamber dimensioned to receive a quantity of water to fill the float valve chamber and the upright growth chamber to an initial level corresponding to the initial growth stage of the root structure of the plant. A float valve is in fluid communication with a water source. The float valve is operable to maintain a terminal water level corresponding to the terminal growth stage of the root structure of the plant.

In some embodiments, a growth basket is coupled to the upright growth chamber. The growth basket is configured suspend the root structure of the plant in each of an air gap and a water level contained within the upright growth chamber, to cause the plant to develop an oxygen root structure in the air gap and a water root structure within the water level.

In some embodiments, the water source comprises a reservoir positioned for a gravity feed of water to the float valve. A quantity of nutrients may be added to the reservoir.

In other embodiments, a drain valve is selectively operable to evacuate water contained within the base.

These and other features, aspects and advantages of the present invention will become better understood with reference to the following drawings, description and claims.

### BRIEF DESCRIPTION OF THE DRAWINGS

FIG. 1 is a perspective view of an extended term hydroponic cultivation apparatus in a multiple unit pipe configuration.

FIG. 2 is a schematic front elevation view showing a starting water level in the multiple unit pipe configuration of the extended term hydroponic cultivation apparatus.

FIG. 3 is a schematic front elevation view showing an ending water level in the multiple unit pipe configuration of the extended term hydroponic cultivation apparatus.

FIG. 4 is a schematic front elevation view showing the starting water level in the single unit pipe configuration of the extended term hydroponic cultivation apparatus.

FIG. 5 is a schematic front elevation view showing the ending water level in the single unit pipe configuration of the extended term hydroponic cultivation apparatus.

FIG. 6 is a schematic front elevation view showing the starting water level in the single unit bucket configuration the extended term hydroponic cultivation apparatus.

FIG. 7 is a schematic front elevation view showing the ending water level in the single unit bucket configuration the extended term hydroponic cultivation apparatus.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide an extended term hydroponic cultivation apparatus and method. The present invention is directed towards the improvement in the hydroponic cultivation method known as the Kratky method. The extended term hydroponic cultivation apparatus allows for plants to grow using the Kratky method over a long term by replenishing the water for the root system as the plants absorb the water, while not over or underwatering.

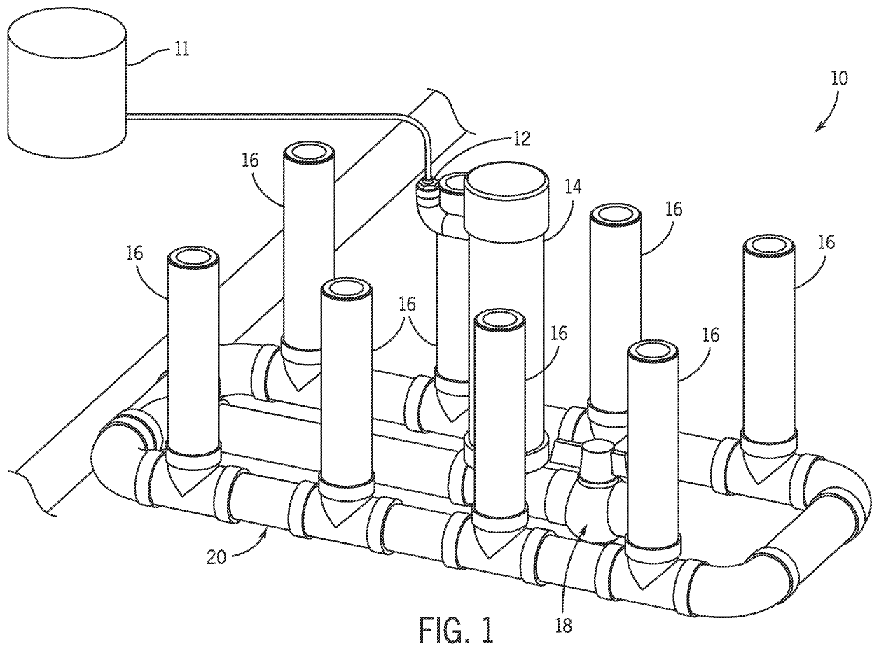

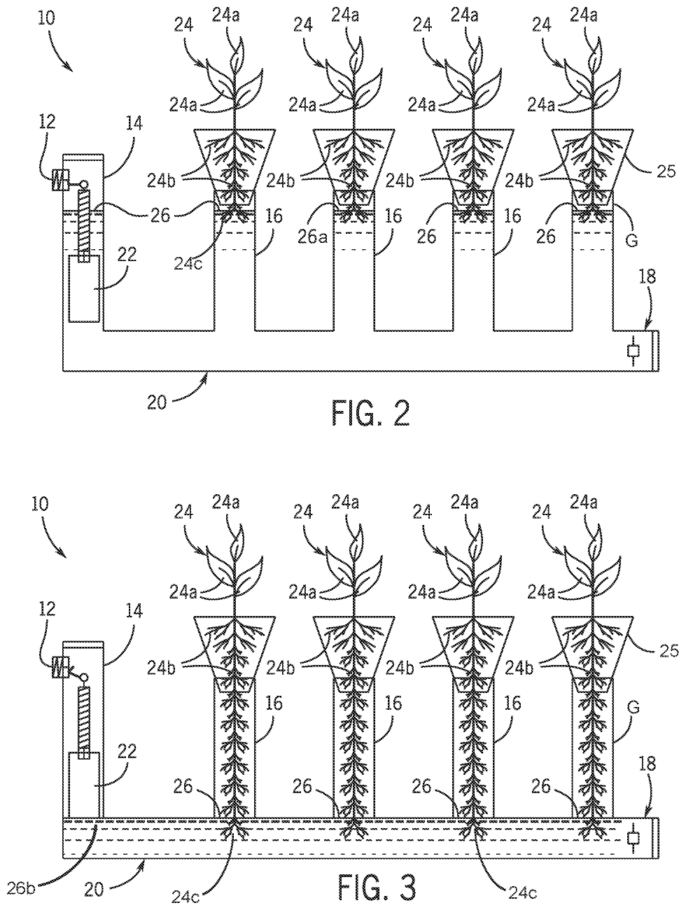

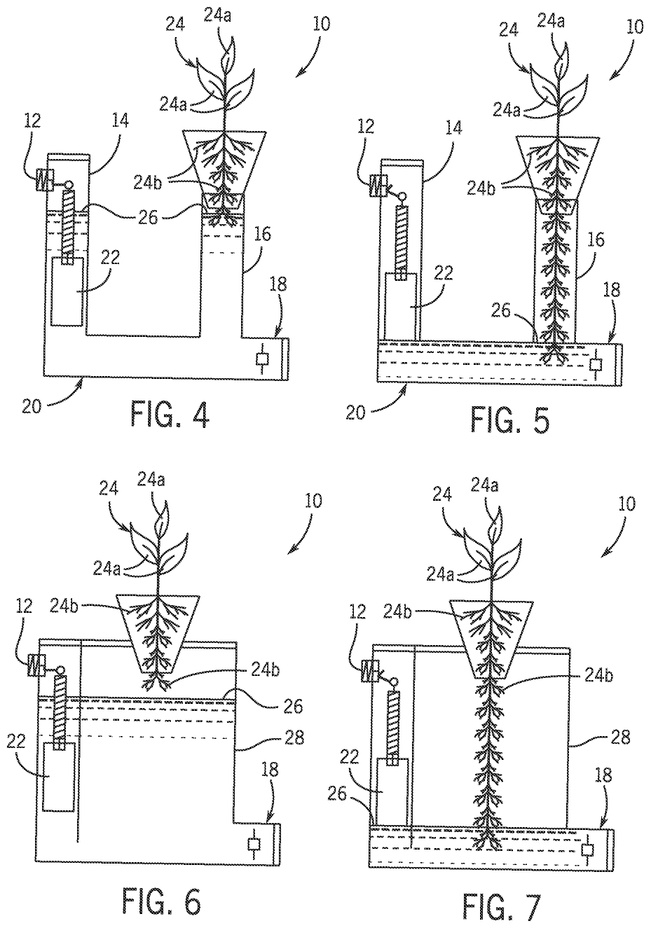

The drawings of FIGS. 1-7 illustrate non-limiting embodiments of the extended term hydroponic cultivation apparatus and method. The extended term hydroponic cultivation apparatus 10 includes a reservoir 11 containing a desired quantity of water for the extended term hydroponic cultivation apparatus 10. The reservoir 11 contains a sufficient quantity of water to provide necessary hydration and nourishment to a type or a variety of plant cultivated by the apparatus 10 and prevailing climatic conditions in which the plants are cultivated. In some embodiments, the reservoir 11 is configured to provide a gravity fed delivery of the water to the hydroponic cultivation apparatus 10. As will be appreciated, the source of water may also be a pressurized water source, such as through a municipal water system or a pressurized well water delivery to the apparatus 10.

A float valve 12 is carried within a float valve housing 14 that is operatively connected to the pressurized water source. The float valve housing 14 is in fluid communication with a plurality of upright growth chambers 16 that are interconnected by a conduit 20. The float valve 12 is configured to fill each of the plurality of upright growth chambers 16 to an initial or starting fill level 26a. As the plants 24 consume water from the apparatus 10 the water level 26 decreases until the plant 24 has reached maturity and the water roots are then retained the growth chamber 16 with the water level 26 maintained in a terminal fill level 26b.

The height of the plurality of growth chambers 16 is selected based on a root growth till maturation of the selected plant variety to be grown in the extended term hydroponic cultivation apparatus 10. A growth basket 25 is provided to support the plant 24 on the growth chamber 16. The growth basket 25 permits a portion of the roots 24 to retain the plant 24 in an upright condition as the plant 24 grows and additional leaf 24a and plant structure develop as the plant 24 matures.

The extended term hydroponic cultivation apparatus 10 is used by filling the reservoir 11 with a water and nutrient solution. The plants 24 are retained in a growth basket 15 and placing a plant 24 into the growth chamber 16 with the roots 24b in contact with the water. As the plant 24 consumes the water the water level 26 decreases creating an air gap G, which prompts the plant 24 to develop oxygen roots 24b in the air gap G. Water roots 24c continue to grow to maintain contact with the water level 26 to wick the water and nutrients to sustain the plant 24. The water roots 24c maintain a saturated condition in the water, and supply water and nutrients to the plant 24 while the oxygen roots 24b allow the plant 24 breath.

As the plant 24 consumes water, the water roots 24b will continue to grow to reach the water level 26, with continued development of additional oxygen root structure 24b. When the water level 26 reach the bottom of the growth chamber 16, and the plant 24 has reached maturity, the float valve 12, is operated by the float 22 carried within the float valve housing 14 will actuate to replenish and maintain the extended term hydroponic cultivation apparatus 10 at a terminal level to sustain plant growth within the apparatus 10 for an indefinite duration.

For long term sustainment of the plant 24, the water and nutrients carried at the base 20 of the apparatus 10 should be flushed at certain intervals to prevent the growth of undesirable contaminants and to replenish the nutrient levels in the water. Accordingly, in some embodiments, a drain valve 18 is provided in communication with the base 20. The drain valve 18 may be opened to evacuate the stale water from the system. Once the base 20 is drained, the drain valve 18 is returned to the closed position to allow the float valve 12 to refill the base 20 with water and nutrients at the terminal growth level.

As will be appreciated from the present disclosure, the extended term hydroponic cultivation apparatus 10 may also be formed with a single growth chamber 16 interconnected with the float valve chamber 14 via a base conduit 20. The float valve 12 is operable to maintain the water level 26 within the apparatus at the terminal level, once the plant 24 has developed the corresponding oxygen root 24b and water root 24c structure. In other embodiments, the growth chamber 16 may be formed by a containment vessel, such as a bucket 28. In this instance, the float valve 12 and is operable to maintain the water level 26 within the growth chamber 16 at the desired terminal level when the plant 24 has matured.

It should be understood, of course, that the foregoing relates to exemplary embodiments of the invention and that modifications may be made without departing from the spirit and scope of the invention as set forth in the following claims.

What is claimed is:

1. A extended term hydroponic cultivation apparatus, comprising:
a growth chamber, having at least one sidewall, a top end, and a bottom end, the growth chamber dimensioned to contain a root structure growth for a plant from an initial stage at a top end of the growth chamber through a terminal stage at a bottom of the growth chamber;
a float valve chamber;
a base in fluid communication with the float valve chamber and the growth chamber, and
a float valve having a float carried within the float valve chamber, the float valve configured for communication with a water source to selectively replenish a water level within the growth chamber when the root structure growth for the plant has reached the terminal stage.

2. The extended term hydroponic cultivation apparatus of claim 1, further comprising:
a growth basket adapted to contain a portion of the root structure growth of the plant, the growth basked coupled with the top end of the growth chamber.

3. The extended term hydroponic cultivation apparatus of claim 1, further comprising:
a plurality of growth chambers disposed in a spaced apart relation; and
a conduit interconnecting each of the plurality of growth chambers with the float valve chamber.

4. The extended term hydroponic cultivation apparatus of claim 1, further comprising:
a reservoir operatively coupled with the float valve, the reservoir configured to provide a gravity feed of a quantity of water carried within the reservoir to the float.

5. The extended term hydroponic cultivation apparatus of claim 1, further comprising:
a drain valve coupled to the base, the drain valve selectively operable between an open position and a closed position, wherein in an open condition a quantity of water be evacuated from the base.

6. The extended term hydroponic cultivation apparatus of claim 1, wherein a height of the growth chamber is selected based on a mature length of the root structure growth.

7. The extended term hydroponic cultivation apparatus of claim 1, wherein the growth chamber comprises a bucket.

8. A extended term hydroponic cultivation system, comprising:
a base configured to contain a quantity of water;
an upright growth chamber in fluid communication with the base, the upright growth chamber defined by at least one cylindrical sidewall, the upright growth chamber dimensioned to contain a root structure of a plant from an initial growth stage to a terminal growth stage;
a float valve chamber in fluid communication with the base, the float valve chamber dimensioned to receive a quantity of water to fill the float valve chamber and the upright growth chamber to an initial level corresponding to the initial growth stage of the root structure of the plant; and
a float valve in fluid communication with a water source, the float valve operable to maintain a terminal water level corresponding to the terminal growth stage of the root structure of the plant.

9. The extended term hydroponic cultivation system of claim 8, further comprising:
a growth basket coupled to the upright growth chamber, the growth basket configured suspend the root structure of the plant in each of an air gap and a water level contained within the upright growth chamber, to cause the plant to develop an oxygen root structure in the air gap and a water root structure within the water level.

10. The extended term hydroponic cultivation system of claim 8, wherein the water source comprises a reservoir positioned for a gravity feed of water to the float valve.

11. The extended term hydroponic cultivation system of claim 10, further comprising:
a quantity of nutrients added to the reservoir.

12. The extended term hydroponic cultivation system of claim 11, further comprising:
a drain valve, selectively operable to evacuate water contained within the base.
